(19) United States
(12) Patent Application Publication
(10) Pub. No.: US 2020/0393731 A1
(43) Pub. Date: Dec. 17, 2020

(54) ELECTROCHROMIC DEVICE WITH SEPARATELY CONTROLLABLE ZONES

(71) Applicant: GENTEX CORPORATION, Zeeland, MI (US)

(72) Inventors: Kevin L. Ash, Grand Rapids, MI (US); Leroy J. Kloeppner, Jenison, MI (US); Michelle M. Carroll, Grand Rapids, MI (US); Michael T. Stephenson, Holland, MI (US)

(73) Assignee: GENTEX CORPORATION, Zeeland, MI (US)

(21) Appl. No.: 16/898,922

(22) Filed: Jun. 11, 2020

Related U.S. Application Data
(60) Provisional application No. 62/860,315, filed on Jun. 12, 2019.

(51) Int. Cl. G02F 1/155; G02F 1/163

(52) U.S. Cl. CPC G02F 1/155; G02F 1/163

(57) ABSTRACT

An electrochromic device includes a first substrate having a first conductive surface, a second substrate having a second conductive surface, and a sealing member joining the first conductive surface of the first substrate to the second conductive surface of the second substrate. The electrochromic device also includes a first busbar spaced apart from a second busbar and both in electrical communication with the first conductive surface of the first substrate, and a third busbar spaced apart from a fourth busbar and both in electrical communication with the second conductive surface of the second substrate. The first substrate, the second substrate, and the sealing member define a chamber. The first busbar is electrically connected with the third busbar to define a first zone. The second busbar is electrically connected with the fourth busbar to define a second zone.

### CROSS-REFERENCE TO RELATED APPLICATOIN

This application claims priority under U.S.C. § 119(e) to U.S. Provisional Application No. 62/860,315 filed on Jun. 12, 2019, entitled “ELECTROCHROMIC DEVICE WITH SEPARATELY CONTROLLABLE ZONES,” the disclosure of which is hereby incorporated by reference in its entirety.

### BACKGROUND

The present disclosure generally relates to an electrochromic device, and more particularly, relates to an electrochromic device having separately controllable zones.

### SUMMARY

In accordance with some aspects of the present disclosure, an electrochromic device is disclosed. The electrochromic device may include a fist substate, a second substrate, an electrochromic medium, a first busbar, a second busbar, a third busbar, and a fourth busbar. The first substate may have a first conductive surface. The second substrate may have a second conductive surface and may be spaced apart from the first substate to define a chamber therebetween. An electrochromic medium may be disposed in the chamber. A first busbar and a second busbar may be disposed on the first substrate. A third busbar and a fourth busbar may be disposed on the second substrate. The first and second busbars may define a first zone. The second and fourth busbars may define a second zone. A transition zone may be defined by a gap between the first and second zones. The transition zone may be operable to gradually transition a color of the electrochromic medium between the first zone and second zone.

In accordance with some other aspects of the present disclosure, an electrochromic device is disclosed. The electrochromic device includes a first substrate having a first conductive surface and a second substrate having a second conductive surface. The electrochromic device also includes a first busbar spaced apart from a second busbar and both in electrical communication with the first conductive surface of the first substrate, and a third busbar spaced apart from a fourth busbar and both in electrical communication with the second conductive surface of the second substrate. At least one conductive surface is transparent or substantially transparent. The first substrate, the second substrate, and the sealing member define a chamber containing an electrochromic medium. The first busbar is electrically connected with the third busbar to define a first zone. The second busbar is electrically connected with the fourth busbar to define a second zone.

In accordance with yet other aspects of the present disclosure, a method is disclosed. The method includes connecting a first busbar of a first substrate of an electrochromic device to a third busbar of a second substrate of the electrochromic device to form a first electrical circuit and define a first zone, connecting a second busbar of the first substrate of the electrochromic device to a fourth busbar of the second substrate of the electrochromic device to form a second electrical circuit and define a second zone, and applying an external voltage across the first electrical circuit in a closed circuit to obtain a colored state in the first zone.

The foregoing summary is illustrative only and is not intended to be in any way limiting.

In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example of an electrochromic device, in accordance with some embodiments of the present disclosure.

FIGS. 2A-2C are examples showing operation of the electrochromic device of FIG. 1, in accordance with some embodiments of the present disclosure.

FIG. 3 is a cross-sectional view of the electrochromic device of FIG. 1, in accordance with some embodiments of the present disclosure.

FIG. 4 is another example of an electrochromic device, in accordance with some embodiments of the present disclosure.

FIG. 5 is another example of an electrochromic device, in accordance with some embodiments of the present disclosure.

FIG. 6 is an example flowchart outlining operations for operating the electrochromic device of FIG. 5, in accordance with some embodiments of the present disclosure.

FIG. 7 is another example of the electrochromic device, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not limiting. Accordingly, other embodiments may be utilized, and other changes may be made, without departing from the spirit or scope of the subject matter presented here. Aspects of the present disclosure, as generally described herein, and illustrated in the figures, can be arranged, substituted, combined, and designed in a wide variety of different configurations, all of which are contemplated and made part of this disclosure.

Electrochromic devices are used in many applications. One such application is a window assembly of a vehicle or airplane. The window assembly may include a window shade that is movable up and down to allow or block light from coming through the window. In some cases, the window shade may be adjusted in various heights to adjust the amount of light coming in through the window. However, window shades may be expensive to manufacture and install. Further, window shades may require regular maintenance for proper functioning. Further, aircraft may have multiple windows and window shades may contribute to the overall weight of the aircraft. However, the overall weight of the aircraft is desired to be kept as low as possible. Thus, shadeless windows (e.g., windows without window shades) may be desired. Such shadeless windows may be fabricated with an electrochromic device, as disclosed herein. The electrochromic device may allow a portion of the window to enter and/or remain in a low transmission state (i.e. a darkened, or dimmed state to minimize or block light from passing through the window) while simultaneously allowing another portion of the window to enter and/or remain in a high transmission state (i.e. little or no coloration thereby allowing light to pass therethrough).

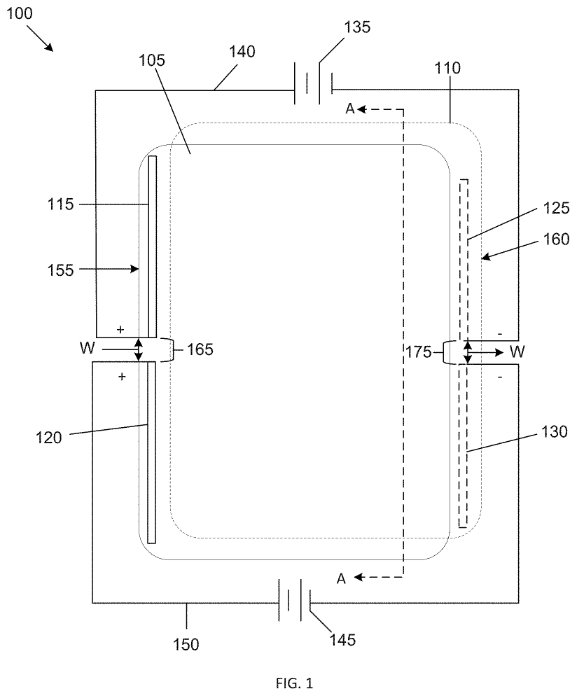

Referring now to FIG. 1, an example of an electrochromic device 100 is shown, in accordance with some embodiments of the present disclosure. The electrochromic device 100 includes a first substrate 105 and a second substrate 110 proximate to the first substrate. The second substrate 110 is spaced apart from and substantially parallel to the first substrate 105. Although not shown, a seal or sealing member may be disposed around the periphery of the first substrate 105 and the second substrate 110 to define an enclosed chamber between the first substrate and the second substrate. The enclosed chamber may be filled with an electrochromic medium between the first substrate 105 and the second substrate 110. Additionally, although not shown, a first transparent conductive material may be disposed on a surface of the first substrate 105 that faces the second substrate 110 and is in contact with the electrochromic medium. Thus, the first transparent conductive material (also referred to herein as the first conductive material) may form a first transparent conductive surface on the first substrate 105. Similarly, a second transparent conductive material (also referred to herein as a second conductive material) may be disposed on a surface of the second substrate 110 that faces the first substrate 105 and is in contact with the electrochromic medium. The second transparent conductive material may form a second transparent conductive surface on the second substrate 110.

The electrochromic device 100 may be used in a wide variety of applications. For example, in some embodiments, the electrochromic device 100 may be configured for use as an electrochromic window, such as in aircrafts and other vehicles, or for architectural buildings. In other embodiments, the electrochromic device 100 may be used in displays and screens for watches, calculators, computers, eye wear, sun visors, information display boards, digital billboards, and the like. Generally speaking, the electrochromic device 100 may be used in any suitable application that desires controlling the amount of light that transmits through or is reflected from the display or window.

Further, the first substrate 105 and the second substrate 110 may be fabricated from a variety of materials, many of which are transparent or substantially transparent in the visible and/or near infra-red regions of the electromagnetic spectrum. The first substrate 105 and the second substrate 110 may be fabricated from, for example, borosilicate glass, soda lime glass, natural and synthetic polymeric resins, plastics, metals, ceramics, and/or composites including polyesters (e.g. PET), polyimides (PI), polycarbonates, polysulfones, polyethylene naphthalate (PEN), ethylene vinyl acetate (EVA), acrylate polymers, as well as cyclic olefin copolymers like Topas®. While particular substrate materials have been disclosed, it is to be understood that numerous other substrate materials may be used in other embodiments, so long as at least one of the first substrate 105 or the second substrate 110 is at least substantially transparent and exhibit appropriate physical properties, such as strength, to be able to operate effectively in conditions of intended use.

In some embodiments, the electrochromic device 100 may be exposed to extreme temperature variation as well as substantial ultra-violet radiation, emanating primarily from the sun. Thus, the substrate materials for the first substrate 105 and/or the second substrate 110 may be chosen to withstand the stresses associated with such operating conditions. Further, in some embodiments, the first substrate 105 and/or the second substrate 110 may include an ultra-violet absorbing layer and/or contain an ultra-violet absorbing material for protection from ultra-violet damage. Similarly, in some embodiments, the first substrate 105 and/or the second substrate 110 may include one or more coating(s) to prevent damage, withstand operating stresses, and otherwise increase the effectiveness of the electrochromic device 100.

Additionally, in some embodiments, the first substrate 105 and the second substrate 110 may be fabricated from the same material, while in other embodiments, different materials may be used for each of the first substrate 105 and the second substrate 110. Further, the thickness of the material used for each of the first substrate 105 and/or the second substrate 110 may vary from one embodiment to another. In some embodiments, the same thickness of the material may be used for both the first substrate 105 and the second substrate 110. In other embodiments, the material used for the first substrate 105 may be of a different thickness than the material used for the second substrate 110. In some embodiments, the first substrate 105 and/or the second substrate 110 may be fabricated from a material having a thickness ranging from about 0.10 millimeters (mm) to about 12.7 mm depending upon the particular application of the electrochromic device 100.

Further, in some embodiments, the first substrate 105 and/or the second substrate 110 may be tempered, heat strengthened, chemically strengthened, and/or laminated prior to or subsequent to being coated with the first and second conductive material, respectively. Additionally, in some embodiments, if the electrochromic device 100 is a mirror or the electrochromic device 100 includes a mirrored surface, depending upon the surface that incorporates the mirror, one of the first substrate 105 or the second substrate 110 may or may not be transparent. Moreover, the spacing between the first substrate 105 and the second substrate 110 may vary from one embodiment to another depending upon the application of the electrochromic device 100.

The first conductive material and the second conductive material may be constructed from various suitable electrically conductive materials, such that at least one of the first conductive material or the second conductive material is transparent or substantially transparent. For example, in some embodiments, one or more layers of the first transparent conductive material and/or the second transparent conductive material may be fabricated from fluorine doped tin oxide (FTO), for example TEC glass, indium/tin oxide (ITO), doped zinc oxide, nickel oxide, indium zinc oxide (IZO), metal oxide/metal/metal oxide (wherein metal oxide can be substituted with metal carbide, metal nitride, metal sulfide, etc.), wire metal grid, or other substantially transparent and highly electrically conductive materials. Generally speaking, any material may be used for the first and/or second transparent conductive materials that: (a) is substantially transparent in the visible, near infra-red, and/or infra-red regions of the electromagnetic spectrum; (b) bonds reasonably well to the substrate (e.g., the first substrate 105 or the second substrate 110) on which it is disposed; (c) maintains the bond when associated with the sealing member; (d) is generally resistant to corrosion from materials contained within the electrochromic device 100; and (e) exhibits minimal diffusion or specular reflectance as well as sufficient electrical conductance. The layer(s) of the first conductive material and the second conductive material serve as electrodes for the electrochromic device 100. In some embodiments, the first conductive material and the second conductive material may be provided in the form of a thin coating or film. The thickness of the first conductive material and the second conductive material may vary from one embodiment to another. Further, the thickness and/or material of the first conductive material may vary from the thickness and/or material of the second conductive material.

The sealing member that is disposed around the periphery of the first substrate 105 and the second substrate 110 to define the chamber for the electrochromic medium may include any material that is configured to adhesively bond to the first and second conductive materials coated on the first and second substrate so that the electrochromic medium does not inadvertently leak out of the chamber or be exposed to the outside atmosphere. Further, in some embodiments, the sealing member may be adhesively bonded directly to the first substrate 105 and/or the second substrate 110 and only partially or not at all to one or both of the first and/or second conductive materials.

The electrochromic medium disposed between the first substrate 105 and the second substrate 110 may be in the form of a transparent liquid solution, gel, or solid. The electrochromic medium is variably transmissive to one or more wavelength bands of light when a particular electrical potential difference is applied between the first conductive material and the second conductive material. In some embodiments, the electrochromic medium may include at least one solvent, at least one cathodic electroactive material, and at least one anodic electroactive material. The cathodic and anodic electroactive materials may be electrochromic. As used herein, the term “electroactive” is defined as a material or compound that undergoes a modification in its oxidation state upon exposure to a particular electrical potential difference. Further, as used herein, the term “electrochromic” is defined as a material or compound that exhibits a change in its extinction coefficient at one or more wavelengths upon exposure to a particular electrical potential difference.

Examples of materials that may be included in the electrochromic medium are, but are not limited to, ferrocene, substituted ferrocenes, phenazine, substituted phenazines, phenothiazine, triphenodithiazines, substituted phenothiazines including substituted dithiazines, thianthrene, substituted thianthrenes, di-tert-butyl-diethylferrocene, 5,10-dimethyl-5,10-dihydrophenazine (DMP), 3,7,10-trimethylphenothiazine, 2,3,7 ,8-tetramethoxy-thianthrene, 10-methylphenothiazine, tetramethylphenazine (TMP), bis(butyltriethylammonium)-para-methoxytriphenodithiazine (TPDT), polymer films such as polyaniline, polythiophene, and polymeric metallocenes, solid transition metal oxides including, but not limited to, oxides of vanadium, nickel, iridium, tungsten, as well as numerous heterocyclic compounds, and viologens (i.e. compounds based upon a 4,4′-dipyridinium structure). In some embodiments, other materials may be used for the electrochromic medium.

The electrochromic medium may be reversibly switched between a colored or substantially colored state and a colorless or substantially colorless state by application of an external voltage. A “colored state” or “substantially colored state” may be defined as a darkened or dimmed color of the electrochromic medium in which the light is at least partially blocked or minimized from passing through the electrochromic medium. A “colorless state” or “substantially colorless state” may be defined as a clear or substantially clear color of the electrochromic medium in which light is generally allowed to pass through the electrochromic medium. The external voltage that is applied to the electrochromic medium to change the color of the electrochromic medium may be applied via a busbar disposed on the first substrate 105 and the second substrate 110.

For example, in some embodiments and as shown in FIG. 1, the electrochromic device 100 includes a first busbar 115 and a second busbar 120 on the first substrate 105. Similarly, the electrochromic device 100 includes a third busbar 125 and a fourth busbar 130 on the second substrate 110. In some embodiments, the first busbar 115 and the second busbar 120 are provided on the surface of the first substrate 105 on which the first conductive material is disposed to establish an electrical connection between the associated busbar and the first conductive material. In some embodiments, the first busbar 115 and the second busbar 120 may be provided on another surface of the first substrate 105 so long as those busbars are able to electrically contact the first conductive material. Similarly, in some embodiments, the third busbar 125 and the fourth busbar 130 are provided on the surface of the second substrate 110 on which the second conductive material is applied, or another surface of the second substrate so long as those busbars are able to electrically contact the second transparent conductive material. The first busbar 115, the second busbar 120, the third busbar 125, and the fourth busbar 130 may be fabricated from metal clips, a metal-filled polymer (i.e. a silver and/or gold epoxy material), a conductive polymer, conductive tape or other electrically conductive material suitable for use as a busbar in the electrochromic device 100.

Further, in some embodiments, the first busbar 115 is connected with the third busbar 125, via an external voltage source 135, to form a first electrical circuit 140, while the second busbar 120 is connected with the fourth busbar 130, via an external voltage source 145, to form a second electrical circuit 150. The first electrical circuit 140 and the second electrical circuit 150 may each be switched between an open circuit configuration and a closed circuit configuration. In some embodiments, a switch or other mechanism may be used to change the open/close circuit configuration of the first electrical circuit 140 and the second electrical circuit 150. Further, a voltage of some magnitude may be applied across the external voltage source 135 of the first electrical circuit 140 or the external voltage source 145 of the second electrical circuit 150 to allow charge flow between a portion of the first conductive material, the second conductive material, and the electrochromic medium. When no external voltage is applied, no charge flows between a portion of the first transparent conductive material, the second transparent conductive material, and the electrochromic medium.

The voltage that is applied across the external voltage source 135 and the external voltage source 145 may vary from one embodiment to another. For example, in some embodiments, the voltage may vary from about 0.1 volts to about 3 volts. Further, the voltage that is applied across the external voltage source 135 may be same as or vary from the voltage that is applied across the external voltage source 145. When a voltage is applied to form a closed circuit, the first and second conductive materials act like conductive electrodes (e.g., anode and cathode) to facilitate charge transfer through the electrochromic medium and alter the optical transmissive properties of the electrochromic medium to reversibly change the color of the electrochromic medium.

Specifically, when a sufficient external voltage is applied (and the electrical circuit is closed), the anodic material in the electrochromic medium is oxidized at the anode surface (e.g., surface of the first or second conductive material that acts as an anode) and the cathodic material in the electrochromic medium is reduced at the cathode surface (e.g., surface of the first conductive material or the second conductive material that acts as a cathode). Because of this applied voltage, the optical transmissive properties of the electrochromic medium adjacent to the busbars is altered. This altered optical transmissive state of the electrochromic medium is collectively referred to herein as the “colored state.” If the electroactive materials are allowed to diffuse within the electrochromic medium, the oxidized anodic material and/or the reduced cathodic material come to a region between the anode and cathode surfaces and undergoes an electron transfer that returns them to their initial redox states they held prior to interaction with the energized electrode surfaces. Thus, due to this applied external voltage, the optical properties of the electrochromic medium may be reversibly changed and controlled.

Similarly, when a sufficient external voltage is not applied or when the electrical circuit is open, the electron transfer through the electrochromic medium does not occur between the anode and the cathode surfaces. Thus, the electrochromic medium adjacent to the busbars across which the external voltage is not applied or that are connected in an open circuit does not change color and remains in or transitions to a colorless or substantially colorless state (collectively referred to herein as “colorless state”). In some embodiments, the transmissivity of the electrochromic medium in the colorless state may be greater than 10%, 20%, 30%, 40%, 50%, 60%, 70%, or 80% for light of a specific range of wavelengths. In some embodiments, the transmissivity of the electrochromic medium in the colored state may be less than 80%, 60%, 50%, 40%, 30%, 20%, 10%, 9%, 8%, 7%, 6%, 5%, 4%, 3%, 2%, 1%, 0.5%, or 0.1% for light of a specific range of wavelengths. In some embodiments, the light of a specific range of wavelengths is near infrared light.

Thus, by not applying an external voltage or by connecting the first electrical circuit 140 and/or the second electrical circuit 150 in an open circuit, the area of the electrochromic medium adjacent to the corresponding busbars (e.g., the first busbar 115, the second busbar 120, the third busbar 125, and the fourth busbar 130) may define a zone that is in the colorless state. Similarly, by applying a sufficient external voltage across the first electrical circuit 140 and/or the second electrical circuit 150 in a closed circuit, the area of the electrochromic medium adjacent to the corresponding busbars (e.g., the first busbar 115, the second busbar 120, the third busbar 125, and the fourth busbar 130) may define a zone that is in the colored state. Thus, by varying the electrical connection in the first electrical circuit 140 and the second electrical circuit 150 between a closed circuit and an open circuit, and by varying the application of the external voltage, the electrochromic device 100 may be configured to include separately controllable zones, with each zone being in a colored state, a colorless state, or a partially colored state. The “partially colored state” may be defined as the color of the electrochromic medium that is lighter than the colored state but darker than the colorless state.

Although only two busbars (e.g., the first busbar 115/the second busbar 120 and the third busbar 125/the fourth busbar 130) are shown on each of the first substrate 105 and the second substrate 110, the number of busbars on each of the first substrate and the second substrate may vary. Further, although the first substrate 105 and the second substrate 110 have been shown as having an equal number of busbars, in some embodiments, the number of busbars on the first substrate may vary from the number of busbars on the second substrate. Additionally, although the first busbar 115 and the second busbar 120 are shown proximate to a first edge 155 of the first substrate 105 and the third busbar 125 and the fourth busbar 130 are shown proximate to a second edge 160 of the second substrate 110, those busbars may be positioned proximate to other edges of the first substrate and the second substrate. Generally speaking, the positioning of the first busbar 115 and the second busbar 120 on the first substrate 105 and the positioning of the third busbar 125 and the fourth busbar 130 on the second substrate 110 may depend upon the location, size, and number of separately controllable zones that are desired.

Further, the dimensions of the first busbar 115, the second busbar 120, the third busbar 125, and the fourth busbar 130 may vary from one embodiment to another. In some embodiments, the first busbar 115, the second busbar 120, the third busbar 125, and the fourth busbar 130 may be provided in the form of a thin conductive coating or strip having same, substantially same, or different thicknesses, widths, and/or lengths. In some embodiments, each of the first busbar 115, the second busbar 120, the third busbar 125, and the fourth busbar 130 may be of the same or substantially same size. In other embodiments, the pairs of busbars that form an electrical circuit may be of the same or substantially same size. For example, in some embodiments, the first busbar 115 and the third busbar 125 may be of the same or substantially same size, while the second busbar 120 and the fourth busbar 130 may be of the same or substantially same size. In other embodiments, at least some of the busbars that are connected to form an electrical circuit may be of different sizes. For example, in such cases, the first busbar 115 may be of a different size than the third busbar 125, and the second busbar 120 may be of a different size than the fourth busbar 130.

Further, the busbars on each substrate may be separated by a gap. For example, the first busbar 115 may be separated from the second busbar 120 by a gap 165, while the third busbar 125 may be separated from the fourth busbar 130 by a gap 170. The width, W, of the gaps 165 and 170 may vary from one embodiment to another. Generally speaking, the width, W, of the gaps 165 and 170 may be dependent upon the sheet resistance of the first conductive material and the second conductive material, respectively. For example, higher the sheet resistance of the conductive material (e.g., the first conductive material and the second conductive material), the smaller may be the width, W, of the gaps 165 and 170. Thus, the width, W, of the gaps 165 and 170 is inversely proportional to the sheet resistance of the first conductive material and the second conductive material, respectively. In some embodiments, the width, W, of each of the gaps 165 and 170 may be about three centimeters. In others embodiments, the width, W, of the gaps 165 and 170 may vary. Further, the width, W, of the gap 165 may be different from the width, W, of the gap 170. In some embodiments, the area of the electrochromic medium adjacent to the gaps 165 and 170 may form a transition zone that is in the partially colored state.

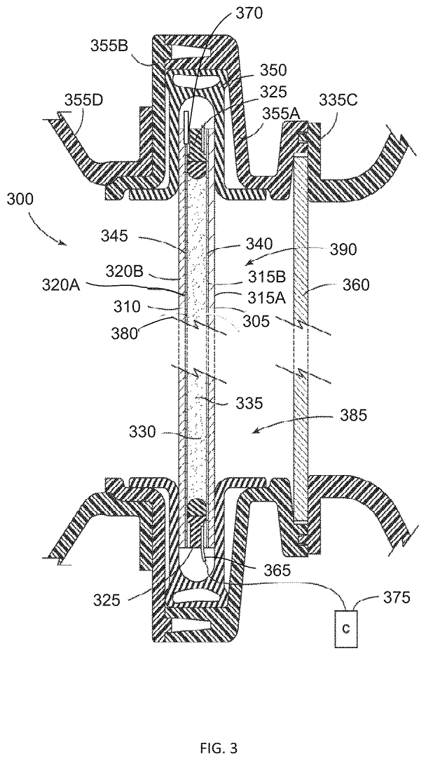

It is to be understood that only certain elements of the electrochromic device 100 are shown in FIG. 1. Additional details of the electrochromic device 100 are shown and discussed in FIG. 3 below.

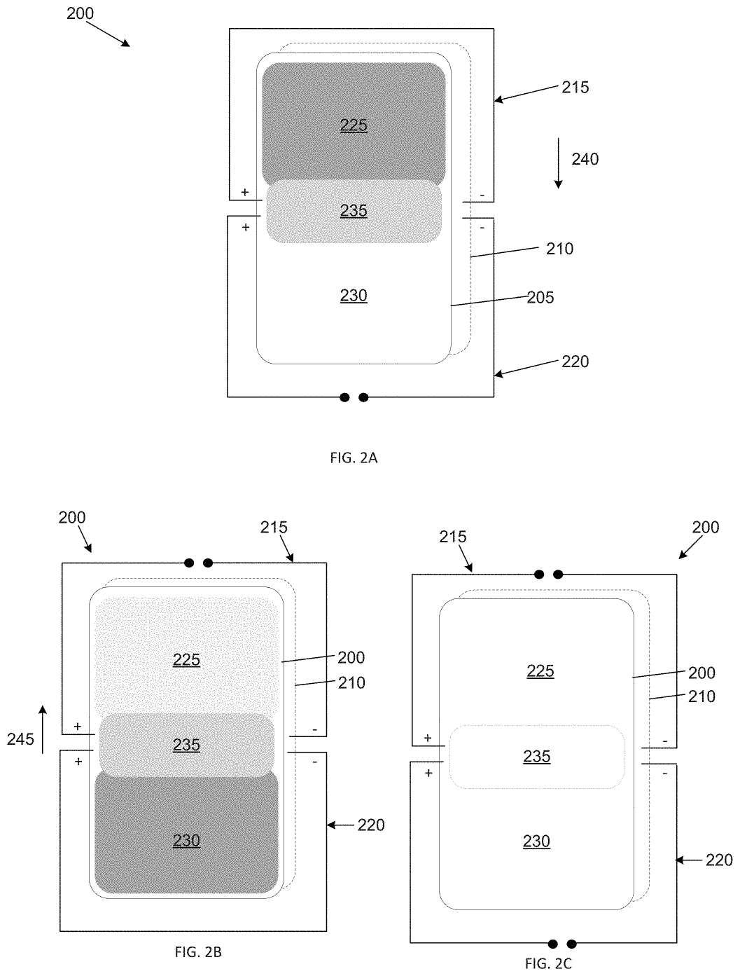

Turning now to FIGS. 2A-2C, an example operation of an electrochromic device 200 is shown in accordance with some embodiments of the present disclosure. The electrochromic device 200 is similar to the electrochromic device 100. Thus, only some elements of the electrochromic device 200 are shown for ease of explanation. However, the electrochromic device 200 is intended to include other elements that are discussed with respect to the electrochromic device 100 above. Similar to the electrochromic device 100, the electrochromic device 200 includes a first substrate 205 and a second substrate 210 to define a chamber therebetween. Also like the electrochromic device 100, the electrochromic device 200 includes a first conductive material coating on the first substrate 205 and a second conductive material coating on the second substrate 210 on the surfaces facing the chamber, such that at least one conductive surface is transparent or substantially transparent. The chamber may be filled with an electrochromic medium.

Further, although not shown, the first substrate 205 includes first and second busbars disposed thereon, while the second substrate 210 may include third and fourth busbars disposed thereon. Only the electrical connections between those busbars are illustrated in the electrochromic device 200. For example, the first busbar on the first substrate 205 may be electrically connected to the third busbar on the second substrate 210, as discussed in FIG. 1 above, to form a first electrical circuit 215. Similarly, the second busbar on the first substrate 205 may be electrically connected to the fourth busbar on the second substrate 210 to form a second electrical circuit 220. The first electrical circuit 215 and the second electrical circuit 220 may be connected, as discussed in FIG. 1 above, in either a closed circuit or an open circuit configuration. Further, an external voltage may be applied across the first electrical circuit 215 and/or the second electrical circuit 220.

For example, as shown in FIG. 2A, the first electrical circuit 215 is shown in a closed circuit configuration, while the second electrical circuit 220 is shown in an open circuit configuration. In the closed circuit configuration, when an external voltage is applied across the first electrical circuit 215, the electrochromic medium adjacent to the busbars forming the closed circuit of the first electrical circuit 215 transitions to a colored state forming a first zone 225. In the open circuit configuration, the electrochromic medium adjacent to the busbars forming the open circuit of the second electrical circuit 220 transitions to a colorless state forming a second zone 230. Further, the first zone 225 and the second zone 230 gradually diffuse together to form a third or transition zone or diffusion zone 235 that is in a partially colored state. In some embodiments, the second electrical circuit 220 may also be in a closed circuit configuration, but the external voltage may not be applied to obtain the colorless state in the second zone 230.

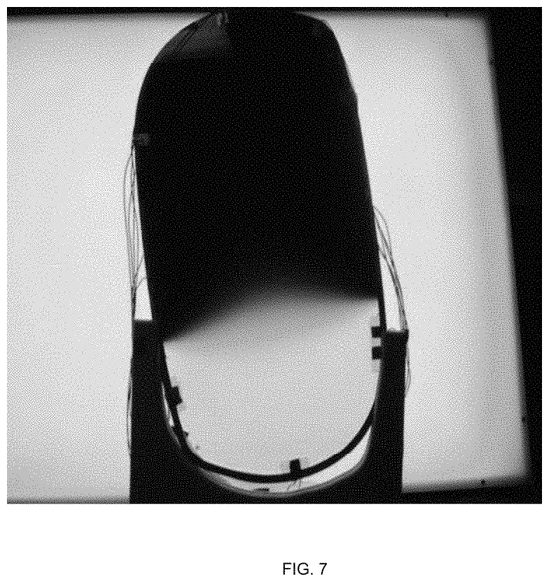

Although the first zone 225, the second zone 230, and the transition zone 235 are shown as distinct zones with sharp boundaries, the boundary of the first zone facing the transition zone is intended to blur with the boundary of the transition zone facing the first zone, as shown for example in FIG. 7. Similarly, the boundary of the second zone 230 facing the transition zone 235 is intended to blur with the boundary of the transition zone facing the second zone. Thus, a portion of the transition zone 235 that is closer to the first zone 225 may be darker than a portion of the transition zone that is closer to the second zone 230. In essence, the various zones form a gradual transition of color from a dark (or substantially dark) color in the colored state to a clear (or a substantially clear) color in the colorless state in the direction of arrow 240.

In some embodiments, an external voltage (not shown in FIG. 2A) of about 1.2 volts may be applied to the first electrical circuit 215 in the configuration of FIG. 2A. Further, in some embodiments, the external voltage may need to be applied for a predetermined period of time to effectuate the transition in the first zone 225 from a colorless state to a colored state. For example, in some embodiments, the external voltage of about 1.2 volts may be applied for about one second to transition the first zone 225 from the colorless state to the colored state. In other embodiments, the amount of time for which the external voltage is applied may depend upon the magnitude of the external voltage and the intensity of the color (e.g., how dark) that is desired in the colored state. Further, in some embodiments, the area of each of the first zone 225, the second zone 230, and the transition zone 235 may vary based upon the dimensions of the busbars and the gap between the busbars on each substrate.

To switch the colors of the first zone 225 and the second zone 230 from the configuration of FIG. 2A to the configuration of FIG. 2B, the first electrical circuit 215 may be opened (or the application of the external voltage may be stopped in the closed circuit configuration of FIG. 2A). Further, the second electrical circuit 220 may be closed and an external voltage may be applied across the second electrical circuit. When the first electrical circuit 215 is in an open circuit configuration (or when external voltage is not applied in the closed circuit), the electrochromic medium in the first zone 225 starts to gradually transition from the colored state of FIG. 2A to a slightly colored state of FIG. 2B and ultimately to a colorless state of FIG. 2C. The amount of time that is needed to transition from the colored state to the colorless state in the first zone 225 may vary from one embodiment to another. For example, in some embodiments, the first electrical circuit 215 may be kept in the open circuit for about four seconds to at least start the transition from the colored state. The about four seconds may or may not be enough to complete the transition to the colorless state. For example, if an external voltage is applied across the first electrical circuit 215 and the first electrical circuit is closed again before the about four seconds, in some embodiments, the first zone 225 may convert back to the colored state before transitioning fully to the colorless state, or may not even start to transition from the state to the colorless state.

Further, although not necessary, in some embodiments, the external voltage may be applied to the second electrical circuit 220 for the about four seconds, more than about four seconds, or less than about four seconds. Thus, when the first electrical circuit 215 is held in an open circuit and the second electrical circuit 220 is held in a closed circuit and an external voltage is applied across the second electrical circuit, the electrochromic medium in the first zone 225 starts to gradually change color from the colored state of FIG. 2A to a slightly colored state of FIG. 2B. Simultaneously or substantially simultaneously, the electrochromic medium in the second zone 230 also starts changing color from the colorless state of FIG. 2A to the colored state of FIG. 2B.

The time needed to transition from the colored state to the colorless state may be different from the time needed to transition from the colorless state to the colored state. In some embodiments, the time needed to transition from the colorless state to the colored state may be less than the time needed to transition from the colored state to the colorless state. For example, as discussed with respect to FIG. 2A, about one second may be needed for the first zone 225 to transition from the colorless state to the colored state, while as discussed with respect to FIG. 2B, about four seconds may be needed for the first zone to start transitioning from the colored state of FIG. 2A to a slightly colored state of FIG. 2B, and even more time may be needed to completely transition to the colorless state of FIG. 2C. Thus, by varying the time the first electrical circuit 215 and the second electrical circuit 220 are held in the open circuit and the time for which the external voltage is applied in the closed circuit, the transitions between the colored state and the colorless state may be controlled.

As shown in FIG. 2B, when the first electrical circuit 215 is opened and the second electrical circuit 220 is closed, the first zone 225 starts transitioning from the colored state of FIG. 2A to the partially colored state of FIG. 2B, while the second zone 230 starts transitioning from the colorless state of FIG. 2A to the colored state of FIG. 2B. The transition zone 235 may also transition color such that the portion of the transition zone that is closer to the first zone 225 is a lighter color, while the portion of the transition zone that is closer to the second zone 230 is a darker color. Thus, the color gradually transitions from dark (or substantially dark) color in the second zone 230 to a clear (or a substantially clear) color in the first zone 225 in the direction of arrow 245.

Now, to cause the first zone 225, the second zone 230, and the transition zone 235 to all go to a colorless state, the first electrical circuit 215 and the second electrical circuit 220 may both be held in an open configuration, as shown in FIG. 2C. When the first electrical circuit 215 and the second electrical circuit 220 are both held in an open circuit, no electron transfer occurs at the anode and cathode and the electrochromic medium in the first zone 225, the second zone 230, and the transition zone 235 gradually return to a colorless state. In some embodiments, a reverse voltage may be applied to the second electrical circuit 220 to quicken the transition of the second zone 230 from the colored state of FIG. 2B to the colorless state of FIG. 2C. In some embodiments, the reverse voltage may be of the same or similar magnitude and applied for the same or similar time as that applied for the transition from the colorless state to the colored state. Thus, in some embodiments, to quicken the transition of the second zone 230 from the colored state to the colorless state, about 1.2 volts of reverse voltage may be applied for about one seconds (e.g., same as applied in FIG. 2A) to transition from the colored state of FIG. 2B to the colorless state of FIG. 2B.

From the configuration of FIG. 2C, the first electrical circuit 215 or the second electrical circuit 220 may again be closed and an external voltage applied to obtain a colored state, and the process of switching the first electrical circuit and the second electrical circuit may repeat. Further, to prevent higher energy loads or damage to the electrochromic medium by excessive electron transfer, in some embodiments, it may be desirable to apply the external voltage to either the first electrical circuit 215 or the second electrical circuit 220 in the closed circuit configuration. In other words, it may be desirable to have only one of the first electrical circuit 215 or the second electrical circuit 220 conducting charge in a closed circuit configuration at a time.

Thus, by applying external voltage and closing the first electrical circuit 215 or the second electrical circuit 220, the first zone 225 or the second zone 230, respectively, may be transitioned to the colored state. Similarly, by opening the first electrical circuit 215 or the second electrical circuit 220 or not applying the external voltage, the first zone 225 or the second zone 230, respectively, may be transitioned to the colorless state. The color of the transition zone 235 may vary based on the state of the first zone 225 and the second zone 230, such that a gradual gradient of color is obtained from the first zone to the second zone or from the second zone to the first zone.

Referring now to FIG. 3, a cross-sectional view of an electrochromic device 300 is shown, in accordance with some embodiments of the present disclosure. The cross-sectional view of the electrochromic device 300 is taken along lines A-A of FIG. 1 and shows additional details about the electrochromic device 100. The electrochromic device 300 is shown installed in a variable transmittance window, although the electrochromic device may be used in any of the applications discussed above.

The electrochromic device 300 includes a front or first substrate 305 and a rear or second substrate 310. The front substrate 305 includes a first surface 315A and a second surface 315B. The rear substrate 310 includes a third surface 320A and a fourth surface 320B. A seal 325 disposed about a periphery of the second surface 315B and the third surface 320A defines a space 330 between the front substrate 305, the rear substrate 310, and the seal. An electrochromic medium 335 is disposed within the space 330. A first transparent conductive material 340 is disposed on the second surface 315B of the front substrate 305. A second transparent conductive material 345 is disposed on the third surface 320A of the rear substrate 310.

The front substrate 305 and the rear substrate 310 may be mounted within a bezel 350. The bezel 350 may be generally elastomeric and secured in place by a middle reveal 355A and an outer reveal 355B. The middle reveal 355A and the outer reveal 355B may be joined to and secured in place by an inner reveal 355C and an outer mounting structure 355D. The inner reveal 355C and the middle reveal 355A secure a dust cover 360 for protecting the electrochromic device 300. The dust cover 360 may be generally transparent and constructed of a polymeric material. The bezel 350 may be composed of a material that is generally strong enough to retain the electrochromic device 300, while at the same time insulating the electrochromic device from structural stresses and forces that may be applied to the bezel 350 by the middle reveal 355A, the outer reveal 355B, the inner reveal 355C, and the outer mounting structure 355D when the vehicle in which the electrochromic device is installed is in operation. The middle reveal 355A and the outer reveal 355B may be made from a thermally conductive plastic that is strong enough to provide structural support for the electrochromic device 300, as well as the bezel 350. When the electrochromic device 300 is in a colored or substantially colored state, the electrochromic device 300 may absorb light, which in turn generates heat. By utilizing a thermally conductive plastic, excess heat that is generated by the electrochromic device 300 may be dissipated through the middle reveal 355A, the outer reveal 355B, and the inner reveal 355C.

The electrochromic device 300 also includes busbars, only a portion of which are visible in FIG. 3. The busbars that are shown include a first busbar 365 on the front substrate 305 and a second busbar 370 on the rear substrate 310. Although a single busbar is shown on each of the front substrate 305 and the rear substrate 310, the electrochromic device 300 may include additional busbars as discussed with respect to FIG. 1. Further, the first busbar 365 may be connected to a control system 375 that is configured to open and close an electrical circuit, as well as apply or remove application of the external voltage, and adjust the relative transmittance of the electrochromic device 300. Although not shown, the second busbar 370 may also be connected to a similar control system. In some embodiments, the first busbar 365 and the second busbar 370 may both be connected to and controlled by the control system 375.

Further, in some embodiments, the electrochromic device 300 may include an isolation line 380 that extends across at least one of the first conductive material 340 and the second conductive material 345 to define independently controlled first and second dimming regions 385 and 390, respectively. The isolation line 380 may be disposed on one or both of the front substrate 305 and the rear substrate 310. The isolation line 380 provides a disconnect of conductivity across the first transparent conductive material 340 and/or the second transparent conductive material 345. Accordingly, the first dimming region 385 can be controlled independently of the second dimming region 390. Likewise, the second dimming region 390 can be controlled independently of the first dimming region 385. Although a single isolation line (e.g., the isolation line 380) is shown in the electrochromic device 300 to define the first dimming region 385 and the second dimming region 390, in some embodiments, additional isolation lines to define more than two independently controlled dimming regions may be provided.

When provided, the isolation line 380 may be constructed by laser ablation, mechanical scribing, or other possible techniques that create a discontinuity across the first conductive material 340 and the second conductive material 345. Further, the isolation line 380 may be linear, arcuate, sinusoidal, or take on any of a variety of shapes as desired. In some embodiments, the isolation line 380 may be as small as three micrometers or larger than three micrometers. Further, in some embodiments, a seal (e.g., a thermally cured epoxy seal) may be introduced proximate the isolation line 380 to provide separation from the electrochromic medium 335. The isolation line 380 may be used when distinct boundaries are desired between the first zone 225, the second zone 230, and the transition zone 235 of FIGS. 2A-2C. Without the isolation line 380, the boundaries between the first zone 225, the second zone 230, and the transition zone 235 maybe blurred and merged together to show a gradual transition of color.

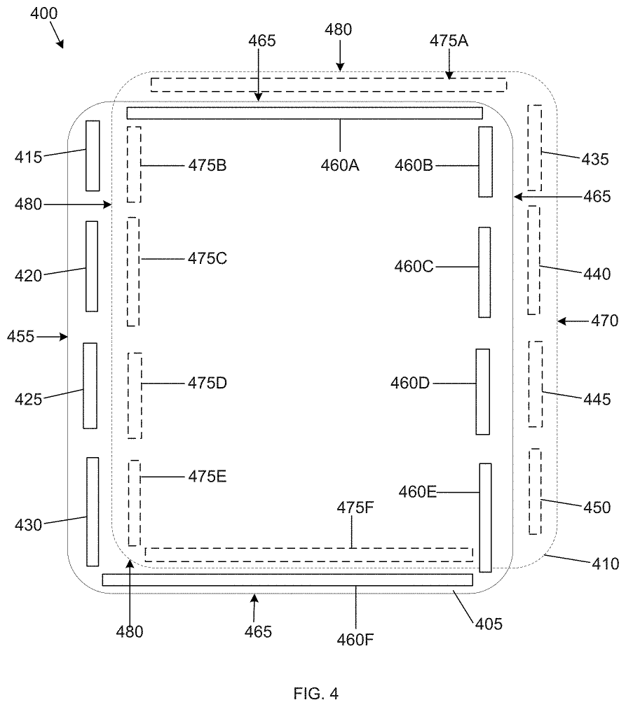

Turning now to FIG. 4, an electrochromic device 400 is shown, in accordance with some embodiments of the present disclosure. The electrochromic device 400 is similar to the electrochromic device 100 in that the electrochromic device 400 also includes a first substrate 405 and a second substrate 410. Although not shown, the electrochromic device 400 also includes a first conductive material on the first substrate 405 and a second conductive material on the second substrate 410, such that at least one of the first conductive material or the second conductive material is transparent or substantially transparent, as well as an electrochromic medium between the first and second conductive materials. The electrochromic device 400 also includes a plurality of busbars. However, in contrast to the electrochromic device 100, which includes two busbars on each substrate, the electrochromic device 400 includes four shorter busbars on each substrate. For example, the electrochromic device 400 includes busbars 415, 420, 425, and 430 on the first substrate 405 and busbars 435, 440, 445, and 450 on the second substrate 410.

In some embodiments, the electrochromic device 400 may include bus bars proximate to multiple edges of the first substrate 405 and the second substrate 410. For example, in some embodiments, in addition to the busbars 415-430, which are provided proximate to an edge 455 of the first substrate 405, the first substrate may also include one or more busbars (e.g., bus bars 460A-460F) proximate to edges 465 of the first substrate. Similarly, in some embodiments, in addition to the busbars 435-450, which are provided proximate to edge 470 of the second substrate 410, the second substrate may also include one or more busbars (e.g., busbars 475A-475F) proximate to edges 480 of the second substrate. In some embodiments, the first substrate 405 and the second substrate 410, and particularly each edge (e.g., the edges 455, 465, 470, 480) of the first substrate and the second substrate, may include a different number of busbars than shown.

Further, in some embodiments, each pair on adjacent busbars may be separated by a minimum gap that may be same as or different from a gap in another pair of adjacent busbars. For example, the busbar 415 may be separated from the busbar 420 by a first gap and the busbar 420 may be separated from the busbar 425 by a second gap that may be same as or different from the first gap. Further, the gap between the busbars 435 and 440 on the second substrate 410 may be same as or different from the first gap between the busbars 415 and 420 on the first substrate 405. Similarly, the gaps between other pairs of busbars on the second substrate 410 may be same as or different from the gaps on the corresponding busbars on the first substrate 405.

Additionally, one busbar on the first substrate 405 may be configured for electrical connection with one busbar on the second substrate 410. For example, in some embodiments, the busbar 415 may be electrically connected to the busbar 435, the busbar 420 may be electrically connected to the busbar 440, the busbar 425 may be electrically connected to the busbar 445, and the busbar 430 may be electrically connected to the busbar 450. In other embodiments, the busbar 415 on the first substrate 405 need not be connected to the busbar 435 on the second substrate 410, but rather, may be connected with any of the busbars 440, 445, or 450 on the second substrate. Similarly, the other busbars on the first substrate 405 may be connected with any busbar on the second substrate 410. Also, when provided, in some embodiments, the busbar 460A may be electrically connected to the busbar 475A, the busbar 460B may be electrically connected to the busbar 475B, the busbar 460C may be electrically connected to the busbar 475C, and so on. Further, in some embodiments, the electrical connection between corresponding busbars on the first substrate 405 and the second substrate 410 may be the same. For example, the busbars 415/435 and the busbars 475B/460B may have the same electrical connection such that the pairs are either both shorted or open or voltage applied.

By connecting each busbar on the first substrate 405 with a busbar on the second substrate 410, those connected busbars may be held in either an open circuit or a closed circuit, and an external voltage may be applied, to define multiple separately controllable zones in which the color of the electrochromic medium is varied between a colored state, a partially colored state, and a colorless state. For example, in the electrochromic device 400, the busbars 415 and 435 may form a closed circuit across which an external voltage may be applied and the busbars 420 and 440 may form another closed circuit across which another external voltage may be applied to obtain a colored state in a top portion of the electrochromic device. Additionally, the busbars 425 and 445 may be held in an open circuit to obtain a transition zone having a partially colored state, and the busbars 430 and 450 may be held in a closed circuit across which no external voltage is applied to obtain a colorless state in a bottom portion of the electrochromic device 400. In other embodiments, the busbars 415 and 435 may form a closed circuit across which an external voltage may be applied, the busbars 430 and 450 may be held in a closed circuit across which another external voltage is applied to obtain a colored state in the top portion and the bottom portion of the electrochromic device 400, while the busbars 420 and 440, and the busbars 425 and 445 may be held in an open circuit to form a larger transition zone between the colored state. Thus, by varying the connection between the various busbars and applying external voltage, various combinations of colored state, colorless state, and partially colored state may be obtained. In other embodiments, the busbars 420, 415, 460A, 460B and 460C of the first substrate 405 and busbars 475C, 475B, 475A, 435 and 440 of the second substrate 410 may form a closed circuit across which an external voltage may be applied to obtain a colored state in the top portion of the electrochromic device 400, while the busbars 425, 430, 460F, 460E and 460D of the first substrate 405 and busbars 475D, 475E, 475F, 450 and 445 of the second substrate 410 may be held in an open circuit or closed circuit across which no external voltage is applied to obtain a colorless state in the bottom half of device 400 while the top half is in the colored state.

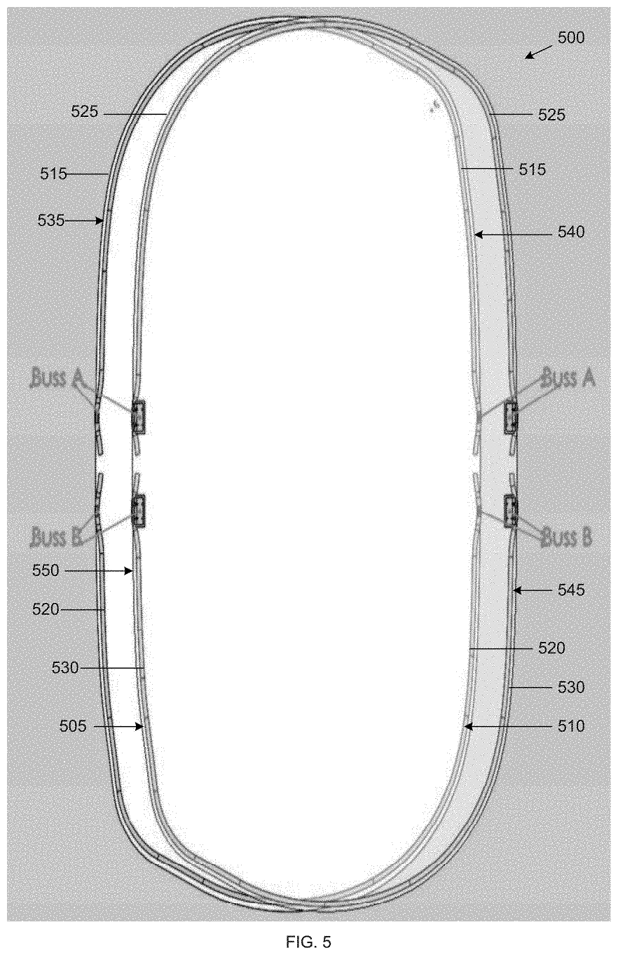

Turning to FIG. 5, another example of an electrochromic device 500 is shown, in accordance with some embodiments of the present disclosure. The electrochromic device 500 is similar to the electrochromic device 100 and the electrochromic device 400 in that the electrochromic device 500 also includes a first substrate 505 and a second substrate 510. The first substrate 505 includes a first busbar 525 and a second busbar 530, while the second substrate 510 includes a third busbar 515 and a fourth busbar 520. The first busbar 525 and the second busbar 530 may extend from proximate an edge 545 of the first substrate 505 to proximate an edge 550 of the first substrate, while the third busbar 515 and the fourth busbar 520 may extend from proximate an edge 535 of the second substrate 510 to proximate an edge 540 of the second substrate. Although not shown, the first busbar 525 may be electrically connected to the third busbar 515 and the second busbar 530 may be electrically connected to the fourth busbar 520 in a manner discussed above with respect to FIG. 1-4. Further, the first busbar 525 is in direct contact with the first conductive material and the third busbar 515 is in direct contact with the second conductive material, and defines the first zone. The first busbar 525 and the third busbar 515 may be deposited parallel and adjacent to one another, but on the two separate conductive material layers. Also, the second busbar 530 may be in direct contact with the first conductive material and the fourth busbar 520 may be in direct contact with the second conductive material, and defines the second zone. The second busbar 530 and the fourth busbar 520 may be deposited parallel and adjacent to one another, but on the two separate conductive material layers. For ease of explanation, the first busbar 525 and the third busbar 515 are collectively referred to herein as “Buss A,” while the second busbar 530 and the fourth busbar 520 are collectively referred to herein as “Buss B.”

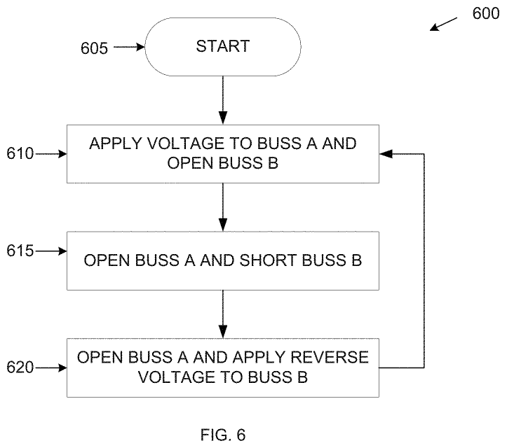

An example operation of the electrochromic device 500 is explained with respect to FIG. 6. Thus, referring to FIG. 6 in conjunction with FIG. 5, an example flowchart outlining operations for a process 600 is shown, in accordance with some embodiments of the present disclosure. The process 600 may include other, additional, or different operations depending upon the particular embodiment. To operate the electrochromic device 500, the process 600 starts at operation 605. At operation 610, a voltage is applied to Buss A (e.g., the first busbar 525 and the third busbar 515), while Buss B (e.g., the second busbar 530 and the fourth busbar 520) is kept in open circuit. In some embodiments, the voltage applied across Buss A may be about 1.2 volts, while other voltages may be used in other embodiments. Further, the voltage may be applied across Buss A and the Buss B may be held in open circuit for a period of time, such as four seconds. By applying voltage across Buss A, the electrochromic medium between the first substrate 505 and the second substrate 510 and adjacent to Buss A reversibly changes to a colored (or substantially colored) state. Further, by holding Buss B in open circuit, no voltage flows across Buss B and the electrochromic medium adjacent to Buss B. Therefore, the electrochromic medium adjacent to Buss B remains in a colorless (or substantially colorless) state. Additionally, the electrochromic medium between the colored (or substantially colored) and colorless (or substantially colorless) states may form a transition or diffusion zone in which the electrochromic medium is in a partially colored state, as shown in FIG. 7.

At operation 615, the voltage across Buss A may be removed and Buss A may be held in an open circuit. Additionally, Buss B may be held in a closed (e.g., short) circuit for a period of time, such as one second. By holding Buss A in open circuit, the electrochromic medium adjacent to Buss A starts changing from the colored (or substantially colored) state of the operation 610 to a colorless (or substantially colorless state). At operation 620 (which is optional), Buss A remains in an open circuit, while a reverse voltage is applied to Buss B for a period of time such as one second to transition the electrochromic medium adjacent to both Buss A and Buss B to a colorless (or substantially colorless) state. The operation 620 may be applied in every cycle, every other cycle, once every ten cycles, etc. of the process 600. Once the operation 620 (when applied) is done, the process 600 returns to the operation 610 and repeats the cycle (e.g., the operations 610-620). The process 600 continues the repeating cycle (e.g., the operations 610, 615, and 620) until a different coloring state is desired.

The process 600 ends at operation 625. Although not shown, in some embodiments, the electrochromic medium adjacent to Buss B may be transitioned to a colored state (or substantially colored) state and electrochromic medium adjacent to Buss A may be transitioned to a colorless (or substantially colorless) state by applying voltage to Buss B and holding Buss A in open circuit, as in the operation 610 but with Buss A and Buss B switched.

It is to be understood that any examples used herein are simply for purposes of explanation and are not intended to be limiting in any way.

T he herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An electrochromic device comprising:
a first substrate having a first conductive surface;
a second substrate spaced apart from the first substrate and defining a chamber therebetween, the second substrate having a second conductive surface;
an electrochromic medium disposed in the chamber;
a first busbar and a second busbar on the first substrate; and
a third busbar and a fourth busbar on the second substrate,
wherein:
the first and third busbars define a first zone;
the second and fourth busbars define a second zone;
a transition zone is defined by a gap between the first and second zones; and
the transition zone is operable to gradually transition a color of the electrochromic medium between the first zone to the second zone.

2. The electrochromic device of claim 1, wherein:
the first zone is operable to a first state of transmissivity by applying a first voltage across the first and third busbars;
the second zone is simultaneously operable to a second state of transmissivity by applying a second voltage across the second and fourth busbars;
the first and second voltages are different; and
the first and second states of transmissivity are different.

3. The electrochromic device of claim 1, wherein:
the first zone is operable to a colored state by applying a first voltage across the first and third busbars; and
the second zone is simultaneously operable to a colorless state by applying no voltage across the second and fourth busbars.

4. The electrochromic device of claim 3, wherein:
the first and third busbars form a first electrical circuit; and
the second and fourth busbars form a second electrical circuit.

5. The electrochromic device of claim 1, wherein the color of the electrochromic medium gradually varies from the first zone to the second zone.

6. The electrochromic device of claim 1, wherein the first zone and the second zone are each separately addressable.

7. The electrochromic device of claim 1, wherein a partially colored state is operably obtained by applying a voltage across the first and the third busbars.

8. The electrochromic device of claim 1, wherein:
the first busbar and the second busbar are spaced apart from one another by a first gap; and
the third busbar and the fourth busbar are spaced part from one another by a second gap.

9. An electrochromic device comprising:
a first substrate having a first conductive surface;
a second substrate having a second conductive surface;
an electrochromic medium disposed between the first substrate and the second substrate;
a first busbar spaced apart from a second busbar and both in electrical communication with the first conductive surface of the first substrate; and
a third busbar spaced apart from a fourth busbar and both in electrical communication with the second conductive surface of the second substrate,
wherein:
at least one of the first conductive surface and the second conductive surface is substantially transparent;
the first busbar is externally electrically connected with the third busbar to define a first zone; and
the second busbar is externally electrically connected with the fourth busbar to define a second zone.

10. The electrochromic device of claim 9, wherein:
each of the first substrate and the second substrate have a first edge and a second edge opposite the first edge;
the first conductive surface of the first substrate is disposed between the first edge and the second edge of the first substrate;
the second conductive surface of the second substrate is disposed between the first edge and the second edge of the second substrate;
the first busbar and the second busbar are proximate to the first edge of the first substrate; and
the third busbar and the fourth busbar are proximate to the second edge of the second substrate.

11. The electrochromic device of claim 9, further comprising:
a transition zone between the first zone and the second zone;
wherein the transition zone gradually transitions a color from the first zone to the second zone.

12. The electrochromic device of claim 11, wherein: when the first zone is in a colored state, the second zone is in a colorless state, and the transition zone is in a partially colored state, the color varies gradually from the colored state in the first zone to the partially colored state in the transition zone to the colorless state in the second zone without a distinct boundary:
between the first zone and the transition zone, and
between the transition zone and the second zone.

13. The electrochromic device of claim 9, wherein the first zone and the second zone are each separately addressable.

14. The electrochromic device of claim 9, wherein:
the first busbar and the second busbar are spaced apart from one another by a first gap; and
the third busbar and the fourth busbar are spaced part from one another by a second gap.

15. A method comprising:
connecting a first busbar of a first substrate of an electrochromic device to a third busbar of a second substrate of the electrochromic device to form a first electrical circuit and define a first zone;
connecting a second busbar of the first substrate of the electrochromic device to a fourth busbar of the second substrate of the electrochromic device to form a second electrical circuit and define a second zone; and
applying a voltage across the first electrical circuit in a closed circuit to obtain a first transmissive state in the first zone.

16. The method of claim 15, wherein a transition zone between the first zone and the second zone gradually transitions between the first transmissive state and a second transmissive state of the second zone, the first and second transmissive states being different.

17. The method of claim 15, wherein the external voltage is applied across the first electrical circuit for a first period of time.

18. The method of claim 17, further comprising:
removing the external voltage across the first electrical circuit after expiration of the first period of time;
configuring the first electrical circuit in an open circuit for a second period of time; and
applying no external voltage across the second electrical circuit in the closed circuit,
wherein:
the first zone remains in the first transmissive state; and
the second zone remains in the second state.

19. The method of claim 18, further comprising:
maintaining the first electrical circuit in the open circuit; and
applying a external voltage across the second electrical circuit,
wherein:
the first zone transitions to the second transmissive state after the expiration of the second period of time; and
the second zone remains in the second transmissive state.

20. The method of claim 18, wherein the second period of time is greater than the first period of time.
